(19) United States
(12) Patent Application Publication
(10) Pub. No.: US 2015/0033109 A1
(43) Pub. Date: Jan. 29, 2015

(54) PRESENTING MUTLIMEDIA OBJECTS WITH ANNOTATIONS

(71) Applicant: Alex Marek, Gulfport, FL (US)

(72) Inventor: Alex Marek, Gulfport, FL (US)

(21) Appl. No.: 13/951,851

(22) Filed: Jul. 26, 2013

(51) Int. Cl. G06F 17/24

(52) U.S. Cl. CPC G06F 17/241
USPC 715/230

(57) ABSTRACT

Various embodiments provide techniques for annotating multimedia objects without editing the original source file of the multimedia object and for sharing the multimedia object and annotations on the internet. In at least some embodiments, a webpage is provided that enables a user to annotate a multimedia object without altering or editing the multimedia object itself and that enables a user to play or otherwise watch the multimedia object with annotations displayed in sync with the multimedia object.

### FIELD OF THE INVENTION

The present invention relates generally to streaming media, and more particularly, relating to a system and method for presenting a streaming multimedia object with annotations without editing the multimedia object.

### BACKGROUND OF THE INVENTION

Sharing multimedia, such as video and the like, on the internet has become a popular method of communication in today's society. Entire social websites are available that center around sharing multimedia with other internet users. Youtube.com is yet one example of a social website centered on sharing multimedia, such as videos, with other internet users.

While sharing multimedia has become a popular method of communication, in most instances users are unable to provide personal and meaningful commentary or annotations on multimedia that is created and shared by others. Today users are limited to providing static, textual comments in a feedback or comment section on a website that hosts the multimedia object. Often, in this scenario, user's text comments quickly become lost among other user comments and are never seen or are difficult to find. Additionally, these text comments cannot be synced to display at specified times during play of the multimedia object.

Heretofore, the only way a user may add annotations to a multimedia object, such as a video shared on the internet, is to download the source file of the video into editing software and actually edit the video to insert the desired annotations. This method is not desirable for many reasons, including requiring downloading the source file, editing the actual source file with expensive and often difficult to use editing software, and then have to upload the edited video source file with annotations to a hosting website so that the video may be shared with the annotations. This current method is also undesirable because the actual downloading and editing of the original video source file may violate numerous end user agreements and licenses. Accordingly, there is a need for a system and/or method that enables a user to annotate multimedia objects and then share the multimedia objects with others without editing the multimedia object source file.

### SUMMARY OF THE INVENTION

The multimedia annotation device, system, and method described herein enables a user to add annotations, e.g. text comments, images, illustrations, audio comments, video, etc., to streaming multimedia objects for presentation to a user viewing the multimedia object without editing the multimedia object to include the annotations and while streaming the multimedia from its source host.

To achieve these and other advantages, in general, in one aspect, a computer-implemented method is provided to present a multimedia object with annotations. The Method included the steps: (a) receiving a request to view a multimedia object that is stored on a server; (b) delivering a webpage to a web browser operating on a user device, the webpage having code associated with the multimedia object, code associated with a transparent overlay, and code associated with annotations of the multimedia object; (c) rendering the webpage by the web browser causing a media player associated with the multimedia object to be presented within the webpage based upon the code associated with the multimedia object, and causing a transparent overlay to be presented within the webpage overlaying the media player based upon the code associated with the transparent overlay; and (d) causing annotations of the multimedia object to be displayed within the transparent overlay based upon the code associated with the annotations.

In general, in another aspect, at least one non-transitory computer-readable storage medium encoded with a plurality of computer-executable instructions that, when executed, perform a method for presenting a multimedia object with annotations. The method including the steps: (a) receiving a request to view a multimedia object that is stored on a server; (b) delivering a webpage to a web browser operating on a user device, the webpage having code associated with the multimedia object, code associated with a transparent overlay, and code associated with annotations of the multimedia object; (c) rendering the webpage by the web browser causing a media player associated with the multimedia object to be presented within the webpage based upon the code associated with the multimedia object, and causing a transparent overlay to be presented within the webpage overlaying the media player based upon the code associated with the transparent overlay; and (d) causing annotations of the multimedia object to be displayed within the transparent overlay based upon the code associated with the annotations.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 illustrates a block diagram of a system in which various principles described herein can be employed, in accordance with one or more embodiments of the invention;

FIG. 2 illustrates an exemplary webpage with an embedded multimedia object and associated media player, and a user interface for annotating the multimedia object, in accordance with one or more embodiments of the invention;

FIG. 3 illustrates an exemplary webpage and annotation interface for creating annotations to the embedded multimedia object, in accordance with one or more embodiments of the invention;

FIG. 4 illustrates an exemplary webpage and annotation interface for creating annotations to the embedded multimedia object, in accordance with one or more embodiments of the invention;

FIG. 5 an exemplary webpage and annotation interface for creating annotations to the embedded multimedia object, in accordance with one or more embodiments of the invention;

FIG. 6 illustrates an exemplary webpage with an embedded multimedia object and associated media player and an annotation presented during play of the multimedia object, in accordance with one or more embodiments of the invention;

FIG. 7 illustrates an exemplary webpage with an embedded multimedia object and associated media player and an annotation presented during play of the multimedia object, in accordance with one or more embodiments of the invention;

FIG. 8 is a flow diagram illustrating an exemplary method of presenting an embedded multimedia object, associated media player, and annotations to the multimedia object in a webpage, in accordance with one or more embodiments of the invention;

FIG. 9 is a flow diagram illustrating an exemplary method of embedding a multimedia object and media player in a webpage and creating annotations to the multimedia object, in accordance with one or more embodiments of the invention; and

FIG. 10 is a flow diagram illustrating an exemplary method of embedding a multimedia object and media player in a webpage and creating annotations to the multimedia object, in accordance with one or more embodiments of the invention

### DETAILED DESCRIPTION

Various embodiments provide techniques for presenting multimedia objects with annotations. Examples of multimedia objects include videos, electronic documents, slide-shows, electronic presentations, and the like. In at least some embodiments, a webpage is provided that enables a user to annotate a multimedia object without altering or editing the multimedia object itself and that enables a user to play or otherwise watch the multimedia object with annotations displayed in sync with the multimedia object.

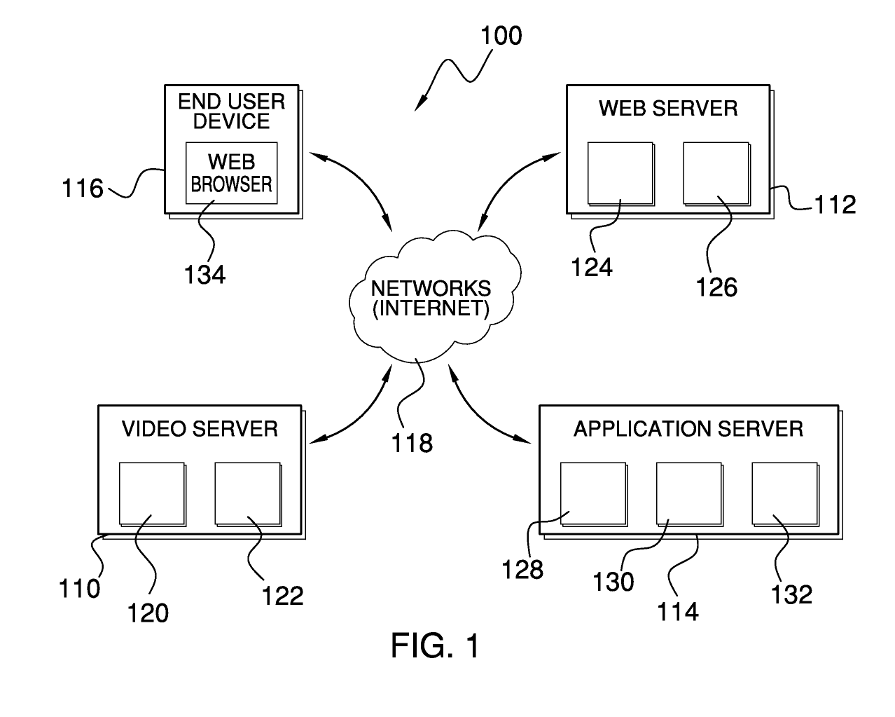

With reference to FIG. 1, there is illustrated a block diagram of a system 100 for annotating multimedia according to an embodiment of the present invention. System 100 includes one or more media servers 110, one or more web servers 112, one or more application servers 114, one or more user devices 116, and a communication network 118.

The media server 110 may be a third party server including a processor, memory, a computer-readable storage media 120, multimedia objects 122, and other necessary hardware and software for executing instructions to provide access to or stream the content of the multimedia object 122 to another device, such as, for example, a computer device operating a web browser. The computer-readable storage media 120 can include, by way of example and not limitation, all forms of volatile and non-volatile memory and/or storage media that are typically associated with a computing device. Such media can include ROM, RAM, flash memory, hard disk, removable media and the like. The media sever 110 may be a video server and the multimedia objects 122 may be videos. Video server 110 may be similar to video servers, such as those made available for access by a user surfing the internet with a web browser, e.g. Youtube.com, Vimeo.com, etc. Video server 110 permits embedding a video player, linked to an identified video 122, in a web page separate from the third party, e.g. separate from youtube.com, permitting viewing of the identified video when users access the separate web page. In its basic application, video server 110 stores videos 122 and delivers them upon demand, such as, for example, by streaming the video over network 118.

The web server 112 includes a processor, memory, computer-readable storage media 124, web pages 126, and related software for implementing the Hypertext Transfer Protocol (HTTP). The computer-readable storage media 124 can include, by way of example and not limitation, all forms of volatile and non-volatile memory and/or storage media that are typically associated with a computing device. Such media can include ROM, RAM, flash memory, hard disk, removable media and the like. Web server 112, operates to serve web pages 126, for example, at the demand of device 116. The web server 112 may be, for example, an Apache web server, Internet Information Services (IIS) web server, nginx web server, and/or any other appropriate web server. The web server 112 may operate to communicate Hypertext Markup Language (HTML) pages, handle HTTP requests, handle Simple Object Access Protocol (SOAP) requests (including SOAP requests over HTTP), and/or perform other related functionality. The web server 112 also may implement technologies such as Hypertext Preprocessor (PHP), Active Server Pages (ASP), Java Server Pages (JSP), Asynchronous JavaScript, JQuery, XML, and/or any other appropriate technology for implementing server-side web application functionality.

The application server 114 includes a processor, memory, storage media 128, annotation database 130, application module 132, and software for executing instructions. The computer-readable storage media 128 can include, by way of example and not limitation, all forms of volatile and non-volatile memory and/or storage media that are typically associated with a computing device. Such media can include ROM, RAM, flash memory, hard disk, removable media and the like. While the application server 114 and the web server are illustrated and described separately, there is no requirement that they are separate devices. In alternative arrangements, the application server 114 and the web server 112 could be combined into a single device. The application server 114 operates to provide software and video annotation data to user device 116 and web server 112. The application module 132 of the application server 114 provides functionality related to the generation of web pages 126 served by web server 112, such as, for example, user interface for adding, editing, removing, and searching of video annotations as further described below. The annotation database 130 includes data related to streaming videos 122 and user generated annotations in connection with the streaming videos. The annotation database 130 may be include one or more relational databases, one or more hierarchical databases, one or more object-oriented databases, one or more flat files, one more structured files, and/or one or more other files for storing data in an organized/accessible fashion. The annotation database 130 may be managed by one or more database management systems in the application server 114, which may be based on technologies such as Microsoft SQL Server, MySQL, PostgreSQL, Oracle Relational Database Management System (RDBMS), a NoSQL database technology, and/or any other appropriate database management technologies.

The end user device 116 may be, for example, a laptop or desktop computer, a tablet computer, a smartphone, a PDA, and/or any other appropriate device. The end user device 116 includes a web browser 134, which may receive, display, and interact with web pages 126 provided by the web server 112 and data provided by the application server 114. The web browser 134 may be, for example, a web browser program such as Internet Explorer, FireFox, Opera, Safari, Chrome, and/or any other appropriate web browser program. The web browser 134 may include and/or communicate with one or more sub-modules that perform functionality such as rendering HTML, rendering raster and/or vector graphics, executing JavaScript, decoding and rendering video data, and/or other functionality. The end user device 116 may receive input from the user of the end user device from input devices (not shown) that are included in or connected to the end user device, such as a keyboard, mouse, touch screen, stylus, and provide data that indicates the input to the web browser 134.

The video server 110, web server 112, application server 114, and the end user device 116 communicate via network 118. The network 118 may include private and/or public wired and/or wireless networks, and/or may include the Internet. Although labeled as a single network 118, it should be understood that this network may include one or more networks that may overlap.

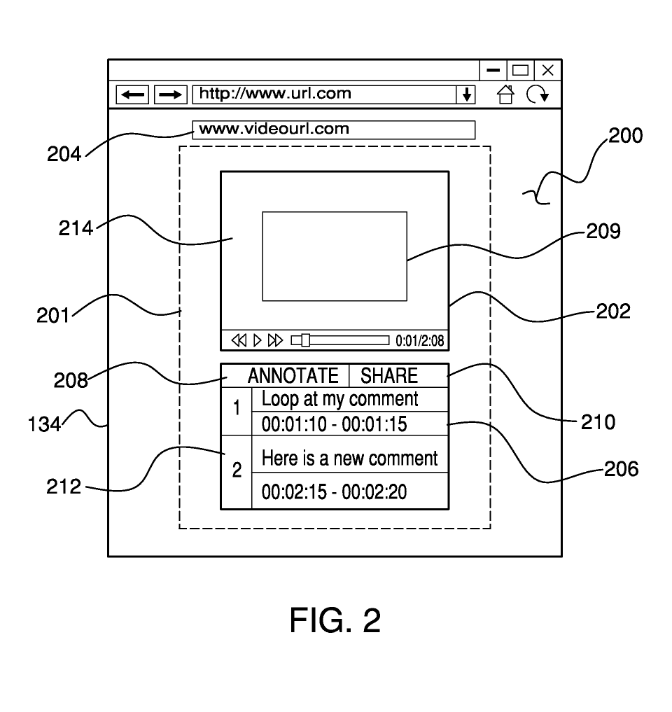

With reference to FIG. 2, there is illustrated, in a somewhat simple form, a webpage 200 in accordance with an embodiment of the invention for presenting multimedia objects with annotations. Webpage 200 may have a more complex design and may be customized based upon user preferences. Webpage 200 is one of webpages 126 and is served by web server 112 to the user device 116 via network 118.

As shown here, webpage 200 is displayed in web browser 134 of the user device 116 and includes an embedded media player 202, representatively illustrated as a video player, a user input field 204, and a user interface 206. Media player 202 is embedded as an object in the webpage 200 and is associated with a multimedia object, such as a video 122 stored on video server 110. Media player 202 and the associated video 122 is embedded based upon a uniform resource locator (URL), e.g. “www.videourl.com” of either a disparate webpage containing the video 122 or the location of where the video is stored and accessible. The video URL is entered into the user input field 204 and is used by the application server 114 to determine where the video is hosted, and if the video can be embedded. If the video can be embedded, the media player 202 associated with the video 122 is presented to the user. Media player 202 includes conventional software controls such as play, pause, step back, step forward, video position scroll bar, a time index, and a sound control that are each activated by a user with a cursor or other interface.

User interface 206 is for creating annotations to a multimedia object, illustrated here as video 122, for presentation to a viewer during playback of the video and in synch with the video, as will be further described. User interface 206 is contained in a transparent overlay layer 201, generally indicated by the dashed line area, which is overlaid upon the media player 202. In other words, the transparent overlay 201 is positioned in a graphic layer that is forward of a graphic layer that the media player 202 is contained.

User interface 206 may include control buttons that can be activated by a user with a cursor or other interface. For example, as illustrated, the user interface 206 includes an “ANNOTATE” button 208 that when activated by a user pops up an annotation interface 209 for adding annotations, a “SHARE” button 210 that when activated by a user provides various options to the user to share the multimedia object and annotations, and a list of annotations 212, each of which corresponding to a time index of the video. In other embodiments, additional or different control buttons may be provided. For example, the “SHARE” button 210 could be substituted with a plurality of buttons, such as an “EMAIL” button that when activated would generate a link to the webpage 200, an “Embed” button that when activated would generate HTML code or the like for a user to copy and paste into the code of another HTML page or object, or button to share the webpage on any number of social media applications, e.g. Twitter, Facebook, etc.

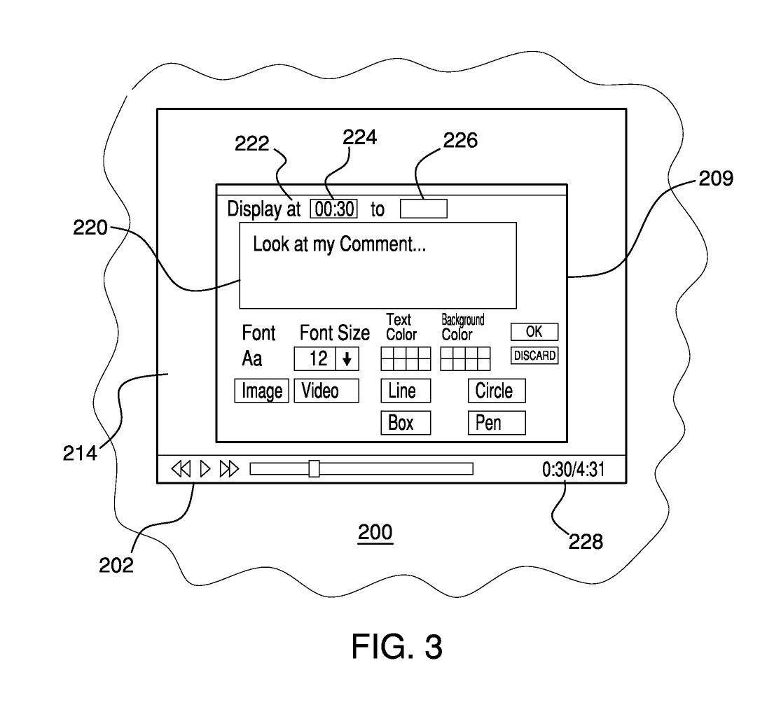

With reference to FIG. 3, there is illustrated an exemplified annotation interface 209 in accordance with an embodiment of the invention Annotation interface 209 is for a user to create annotations to the multimedia object, illustrated here as a video 122 and associated media player 202, for presentation to a user while viewing the video (multimedia object). The annotation interface 209 is presented to a user upon activating the “ANNOTATE” button 208 and is located within the transparent overlay 201 and positioned over the media player 202. Preferably, the annotation interface 209 is positioned over the media player 202 within the video portion 214 thereof.

The annotation interface 209 includes several control buttons that can be activated by a cursor or the like for creating annotations to the video 122 (multimedia object). In the illustrated example, the control buttons include a “Font” button for a user to select a font style for a text comment, a “Font Size” button for a user to select the font size for a text comment, a “Font Color” button for a user to select the color of the font for a text comment, a “Background Color” button for a user to select a color of the background of the annotation, a “Ok” button for accepting the created font, and a “Cancel” button to clear the annotation field 220 and/or hide the annotation interface 209.

In addition to a text comment or alternative to a text comment, a user may insert an image, a video, an audio comment, or make a drawing in the annotation field 220. To insert an image, a user would activate the “Image” button and then would be provided with pre-selected image options or allowed to upload an image to be inserted. In an embodiment, a user may be presented with an option to take a picture with a camera of the end user device 116 to be uploaded and inserted. To insert a video, a user would activate the “Video” button and then would be provided with pre-selected video options or allowed to upload a video to be inserted. In an embodiment, a user may be presented with an option to take video with a video camera of the end user device 116 to be uploaded and inserted. To insert an audio comment, a user would active the “Audio” button and then would be provided with pre-selected audio options or allowed to up load an audio file to be inserted. In an embodiment, a user may be presented with an option to record an audio comment using a micro-phone of the end user device 116 to be uploaded and inserted.

In either of the video or audio options, the user may be presented with an option to adjust the volume of the multimedia object during presentation of the video or audio annotation so that the sound of the video or the audio annotation can be heard over the sound of the multimedia object.

Alternatively, a user may select various drawing controls, such as the “Line” button, “Circle button”, “Box” button, or “Pen” button which present the user with drawing tools for creating illustrations in the annotation field 220.

The annotation interface 209 also includes annotation time index 222 including an annotation start time 224 and an annotation end time 226. The annotation start time 224 and the annotation end time 226 correspond to the video time index 228 and when the annotation will be presented and the duration that it is presented. In the illustrated example, the annotation start time is indicated at 224, representatively 30 seconds, which corresponds to the time index of the video 226. In embodiments, the annotation start time will correspond to the video time index that the user activated the “ANNOTATE” button. Alternatively, a user may manually enter an annotation start time 224 in the corresponding field. The end time 226 will be entered into the corresponding field by a user. Alternatively, a display time field (not shown) may be provided for a user to enter the time to display the annotation, for example an entry of 30 would correspond to a 30 second duration for the annotation to be presented/displayed during playing of the video (multimedia object).

In embodiments, a user may resize the annotation field 220 to adjust the size of the display size of the annotation during playing of the video (multimedia object). In this embodiment, when a user moves a cursor or the like over an edge of the annotation field 220 the user would be presented with resize handles that can be activated to resize the size of the annotation field. Additionally, the position that the annotation is displayed relative to the media player 202 and video portion 224, may be controlled or otherwise specified by moving the annotation interface 209 to the desired position within the video portion 224 of the media player 202. Alternatively, a more advanced user operation may be provided wherein a user may manually enter a coordinate location of a position to display the annotation relative to the media player 202.

One or more annotations may include a hyperlink that, when activated, may take a user to a separate webpage or website, display an advertisement, or cause another event to take place. For example, a text comment can include a hyperlink that when clicked or activated by the user, a separate webpage or website is opened. Similarly, an image, video, or drawing object can include a hyperlink that when the image, video, or drawing object is clicked or activated by the user, a separate webpage or website is opened. Accordingly, the hyperlink is associated with the annotation and is active when the annotation is visible.

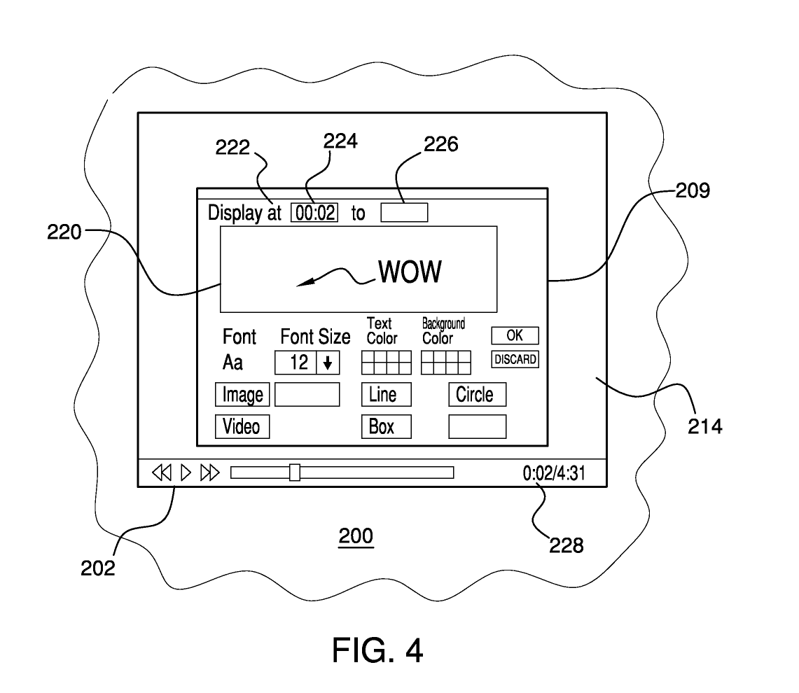

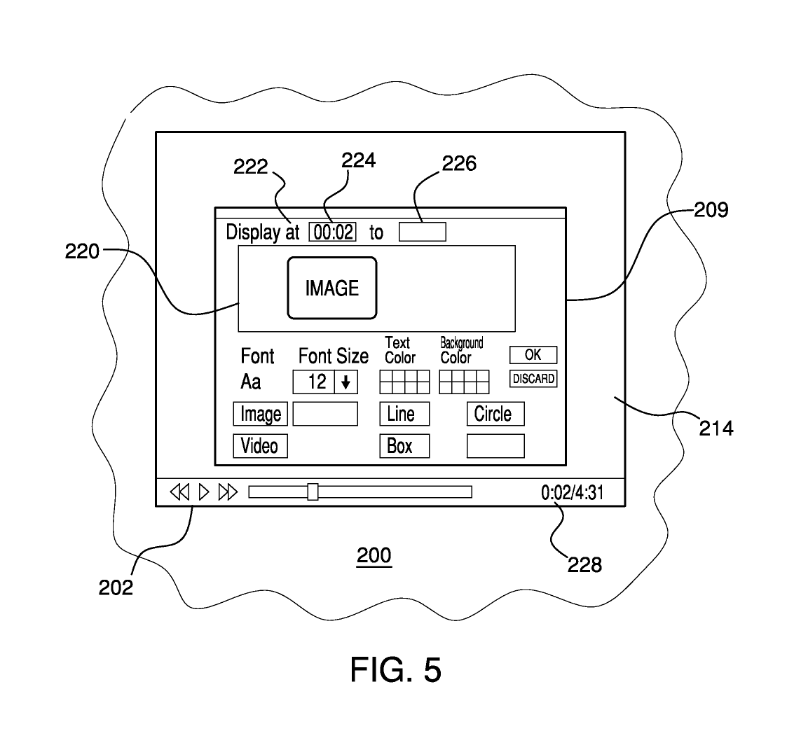

As previously described, an annotation may be a text comment, representatively illustrated in FIG. 3. Alternatively, an annotation may be a user generated drawing, representatively illustrated in FIG. 4. Alternatively yet, an annotation may be an image selected from a pre-defined set of images that are presented to the user for selection or an image that is uploaded by the user, representatively illustrated in FIG. 5. Similar to the image, an annotation may be a video that when displayed would begin playing.

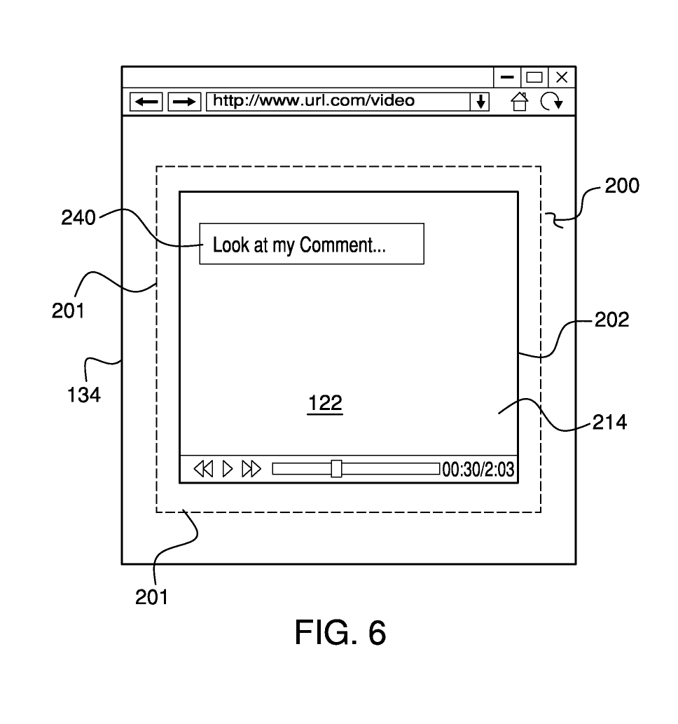

FIG. 6 illustrates an example of webpage 200 for playing a multimedia object, here shown as a video 122 and media player 202, which has been annotated by a user. Similar to adding/editing annotations, the media player 202 is embedded as an object in the webpage and is associated with a multimedia object, such as a video 122 that is stored on video server 110. Media play 202 and the associated video 122 is embedded based upon a uniform resource locator (URL), e.g. “www.videourl.com” of either a disparate webpage containing the video 122 or the location of where the video is stored and accessible. Webpage 200 may have a more complex design and may be customized based upon user preferences. Webpage 200 is one of webpages 126 and is served by web server 112 to the user device 116 via network 118. The webpage 200 includes a transparent overlay layer 201, generally indicated by the dashed line area, which is overlaid upon the media player 202. In other words, the transparent overlay 201 is positioned in a graphic layer that is forward of a graphic layer that the media player 202 is contained.

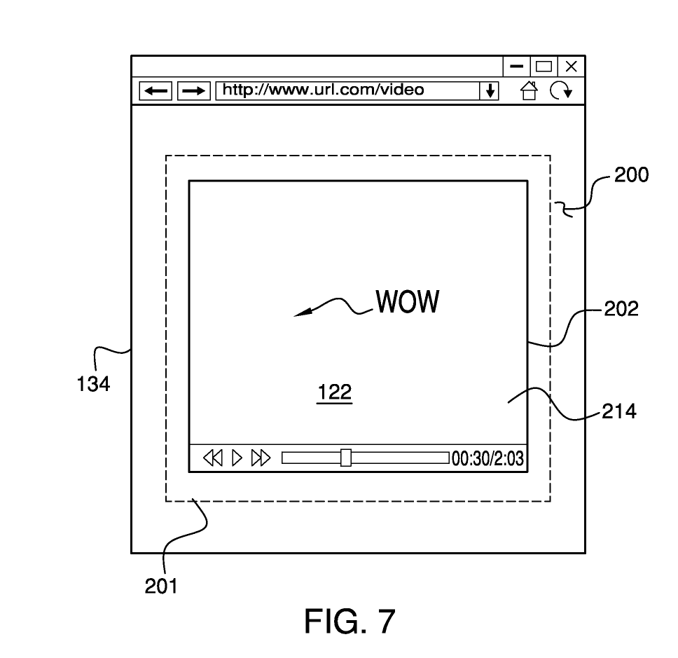

Annotations, such as text comment 240 shown in FIG. 6 or illustration 242 shown in FIG. 7, are presented to the viewer in sync with the play back of the video 122. The annotations, when presented to the viewer, are located within the transparent overlay 201 and over top of the media player 202. Preferably, the annotations are located within the transparent overlay 201 and over top the video portion 214 of the media. Each annotation is presented to the view at the time and duration determined by the user who created the annotation. Multiple separate annotations may be presented concurrently or in an overlapping time period. In addition to presenting the annotations overtop of the media player in the specified location and time period, a list of annotations (not shown) may be provided next to the media player 202. The list of annotations may be populated in sync with the play of the multimedia object, with the most recent annotation positioned at the top of the list. A user may select an annotation in the list and cause the media player to go to the point in the multimedia object that is associated with that annotation.

In embodiments, a search engine can search annotations of the multimedia objects created by users. This would allow the searching user to locate specific portions of the multimedia object that the user would like to view. A user may select an annotation from the result list and cause the media player to go to the point in the multimedia object that is associated with the selected annotation.

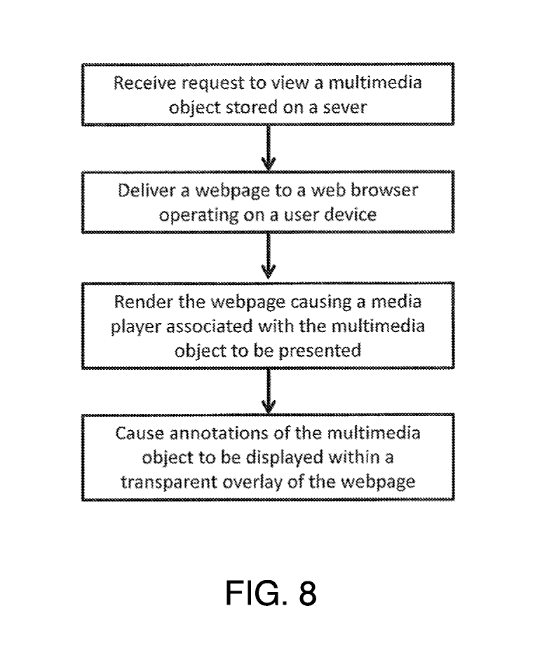

FIG. 8 is a flow diagram that describes steps in a method 800 in accordance with one or more embodiments of the invention for presenting multimedia objects with annotations. The method 800 is performed by system 100. While the method 800 is described serially, the steps or operations can be performed by separate elements in conjunction or in parallel, whether asynchronously or otherwise. Unless otherwise specified, there is no requirement that the steps of the method 800 are performed in the order described.

Step 802 receives a request to view a multimedia object that is stored on a server. For example, a user browsing the internet on a web browser operating on a user device activates a link on a website of the invention or on another website to view the multimedia object and annotations of the multimedia object. The link includes information related to the multimedia object, such as the location that the multimedia object is hosted. The link also includes information related to the annotations of the multimedia object. Alternatively, the link includes information of a record in a database that is associated with information related to the multimedia object and associated with information related to the annotations of the multimedia object.

Step 804 delivers a webpage 200 to the web browser 134 operating on the user device 116. The webpage 200 has code associated with the multimedia object 122, code associated with a transparent overlay 201, and code associated with annotations 212 of the multimedia object.

Step 806 renders the webpage 200 by the web browser 134 causing a media player associated with the multimedia objected 122 to be presented within the webpage based upon the code associated with the multimedia object 122, and causing a transparent overlay 201 to be presented within the webpage overlaying the media player 202 based upon the code associated with the transparent overlay. For example, the code associated with the multimedia object may be like <iframe width=“560” height=“315” src=“//www.youtube.com/embed/p09Q1QQazo0” frameborder=“0” allowfullscreen></iframe>. And for example, the code associated with the transparent overlay may be like <div id=divOverlay” style=“div-overlay><canvas id=“canvasOverlay” width=“100” height=“100” style=“canvas-overlay></div>.

Step 808 causes annotations 212 of the multimedia object 122 to be displayed within the transparent overlay 201 based upon the code associated with the annotations. For example, as the multimedia object 122 is played back to the user for viewing by the media player 202, annotations associated 212 with the multimedia object 122 are displayed within the transparent overlay 201 in sync with the play back of the multimedia object. The multimedia object 122 is requested from the multimedia server 110 and is streamed to the media player 202 and viewed at website 200. For example, the code associated with the annotations may be <div id=“divOverlay” style=“div-overlay><a href=“someotherurl”><img src=“someimagepath”/></a><canvas id=“canvasOverlay”width=“100”height=“100”style=“canvas-overlay></canvas><p>Some text goes here</p></div>.

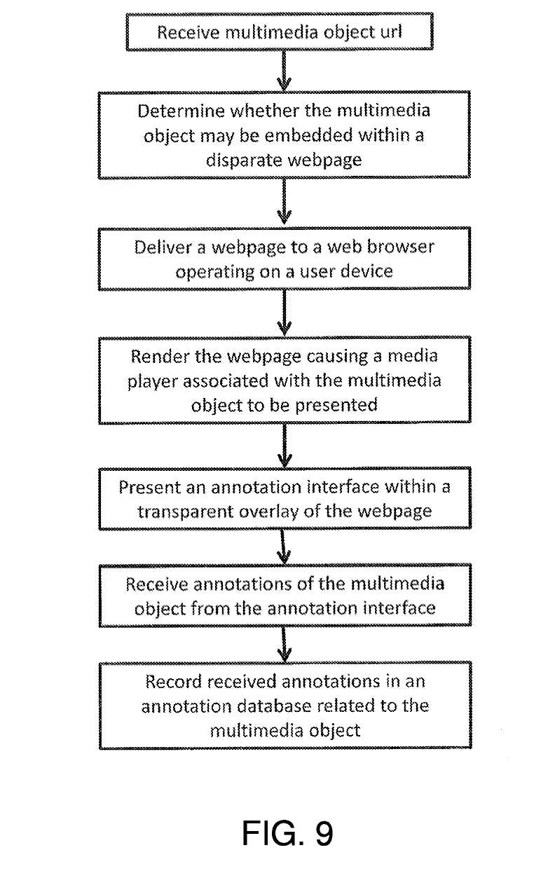

FIG. 9 is a flow diagram that describes steps in a method 900 in accordance with one or more embodiments of the invention for presenting multimedia objects with annotations. The method 900 is performed by system 100. While the method 900 is described serially, the steps or operations can be performed by separate elements in conjunction or in parallel, whether asynchronously or otherwise. Unless otherwise specified, there is no requirement that the steps of the method 900 are performed in the order described.

Step 902 receives a multimedia object URL, for example, by a user entering a URL into the multimedia object URL field 204 of website 200. The multimedia object URL may be a direct URL to the multimedia object or may be a URL of a disparate webpage that contains the multimedia object.

Step 904 determines whether the multimedia object 122 associated with the received multimedia object URL is able to be embedded in a webpage other than its source webpage. For instance some multimedia servers do not permit third party server access to multimedia objects. The application server 114 operates to determine whether the server hosting the multimedia object permits third party embedding, and further operates to generate code associated with the multimedia object for embedding in webpage 200.

Step 906 delivers a webpage 200 to the web browser 134 operating on the user device 116. The webpage 200 has code associated with the multimedia object 122, code associated with a transparent overlay 201, and code associated with the user interface 206 and the annotation interface 209.

Step 908 renders the webpage 200 by the web browser 134 causing a media player 202 associated with the multimedia objected 122 to be presented within the webpage based upon the code associated with the multimedia object 122, and causing a transparent overlay 201 to be presented within the webpage overlaying the media player 202 based upon the code associated with the transparent overlay. For example, the code associated with the multimedia object may be like <iframe width=“560” height=“315” src=“//www.youtube.com/embed/p09Q1QQazo0” frameborder=“0” allowfullscreen></iframe>. And for example, the code associated with the transparent overlay may be like <div id=“divOverlay” style=“div-overlay><canvas id=“canvasOverlay” width=“100” height=“100” style=“canvas-overlay></canvas></div>.

Step 910 presents a user interface 206 including an annotation interface 209 within the transparent overlay 201 of the webpage 200. For example, at the initial rendering of the webpage 200, a user is presented with interface 206 and upon the user activating the “ANNOTATE” button, the user is presented with annotation interface 209 for creating annotations to the multimedia object 122.

Step 912 receives one or more annotations 212 from created by the user with the annotation interface 209. Each annotation includes data related to the annotation, including a unique identifier, annotation contents, user id, multimedia object id, annotation start time, annotation duration or end time, coordinate position of the annotation relative to the media player, size of the annotation, font type, font size, font color, background color, etc. For example, the annotation and its related data are received by the application server 114 when a user activates the “OK” button in the annotation interface 209.

Step 914 records the received annotation and its related data within an annotation database 130 for later retrieval when the multimedia object is replayed with the annotations. Non-text annotations, including audio, images, or video are saved to storage so that they can later be retrieved during playing of the associated multimedia object. For example, the non-text annotations may be saved to storage 124 or storage 128.

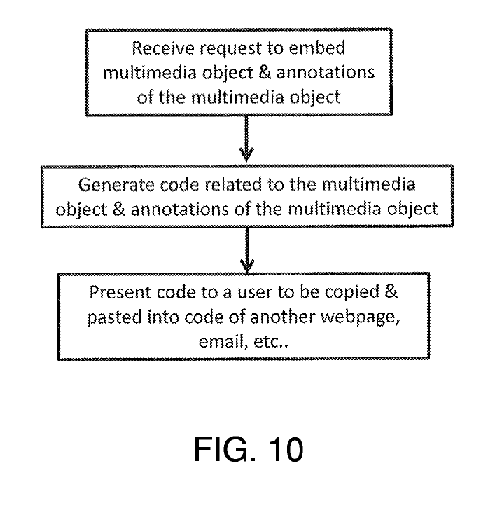

FIG. 10 is a flow diagram that describes steps in a method 1000 in accordance with one or more embodiments of the invention for presenting multimedia objects with annotations. The method 1000 is performed by system 100. While the method 1000 is described serially, the steps or operations can be performed by separate elements in conjunction or in parallel, whether asynchronously or otherwise. Unless otherwise specified, there is no requirement that the steps of the method 1000 are performed in the order described.

Step 1002 receives a request from a user to embed a multimedia object 122 and the user created annotations 212. For example, the request is received upon a user activating the “SHARE” button of the user interface 206 or a similar control button displayed/presented to a user within webpage 200 or the like. The request is received by the application server 114 upon activation of the “SHARE” button or similar button.

Step 1004 generates code by the application server 114 that permits a user to embed the multimedia object 122 and associated user created annotations 212 in code of another website, in an email, social media application, etc. The generated code may include a portion that is associated with the multimedia object 122 and a portion that is associated with the user created annotations. For example, the code may generate a link or object within the webpage, email, etc. that the code is pasted, and that link may be related to both the original source location of the multimedia object and the user created annotations. Alternatively, the code and/or link may be associated with a database record that corresponds to the original source location of the multimedia object and the user created annotations.

Step 1004 presents the code generated in step 1002 to the user, for example in a pop-up box or another field on webpage 200. The user then may copy and paste the code as desired.

A number of embodiments of the present invention have been described. Nevertheless, it will be understood that various modifications may be made without departing from the spirit and scope of the invention. Accordingly, other embodiments are within the scope of the following claims.

What is claimed is:

1. A computer-implemented method comprising:
receiving a request to view a multimedia object that is stored on a server;
delivering a webpage to a web browser operating on a user device, said webpage having code associated with said multimedia object, code associated with a transparent overlay, and code associated with annotations of said multimedia object;
rendering said webpage by said web browser causing a media player associated with said multimedia object to be presented within said webpage based upon said code associated with said multimedia object, and causing a transparent overlay to be presented within said webpage overlaying said media player based upon said code associated with said transparent overlay; and
causing annotations of said multimedia object to be displayed within said transparent overlay based upon said code associated with said annotations.

2. The computer-implemented method of claim 1, wherein said multimedia object comprises a video.

3. The computer-implemented method of claim 1, wherein causing annotations further comprises displaying said annotations based upon a time index of said multimedia object.

4. The computer-implemented method of claim 1, wherein at least one annotation of said annotations comprises text.

5. The computer-implemented method of claim 1, wherein at least one annotation of said annotations comprises a hyperlink.

6. The computer-implemented method of claim 1, wherein at least one annotation of said annotations comprises an image.

7. The computer-implemented method of claim 1, wherein causing annotations further comprises displaying said annotations within said transparent overlay at a position relative to the position of said media player.

8. The computer-implemented method of claim 7, wherein said position is within a border of said media player.

9. The computer-implemented method of claim 7, wherein said position is exterior of a border of said media player.

10. The computer-implemented method of claim 1, wherein receiving a request further comprises a user activating a hyperlink on a webpage, said hyperlink including first information associated with said multimedia object and second information associated with said annotations.

11. The computer-implemented method of claim 10, wherein said multimedia object is a video.

12. At least one non-transitory computer-readable storage medium encoded with a plurality of computer-executable instructions that, when executed, perform a method for presenting a multimedia object with annotations, the method comprising:
receiving a request to view a multimedia object that is stored on a server;
delivering a webpage to a web browser operating on a user device, said webpage having code associated with said multimedia object, code associated with a transparent overlay, and code associated with annotations of said multimedia object;
rendering said webpage by said web browser causing a media player associated with said multimedia object to be presented within said webpage based upon said code associated with said multimedia object, and causing a transparent overlay to be presented within said webpage overlaying said media player based upon said code associated with said transparent overlay; and
causing annotations of said multimedia object to be displayed within said transparent overlay based upon said code associated with said annotations.

13. The at least one non-transitory computer-readable storage medium of claim 12, wherein said multimedia object comprises a video.

14. The at least one non-transitory computer-readable storage medium of claim 12, wherein causing annotations further comprises displaying said annotations based upon a time index of said multimedia object.

15. The at least one non-transitory computer-readable storage medium of claim 12, wherein at least one annotation of said annotations comprises text.

16. The at least one non-transitory computer-readable storage medium of claim 12, wherein at least one annotation of said annotations comprises a hyperlink.

17. The at least one non-transitory computer-readable storage medium of claim 12, wherein at least one annotation of said annotations comprises an image.

18. The at least one non-transitory computer-readable storage medium of claim 12, wherein causing annotations further comprises displaying said annotations within said transparent overlay at a position relative to the position of said media player.

19. The at least one non-transitory computer-readable storage medium of claim 12, wherein receiving a request further comprises a user activating a hyperlink on a webpage, said hyperlink including first information associated with said multimedia object and second information associated with said annotations.

20. The at least one non-transitory computer-readable storage medium of claim 12, wherein said multimedia object is a video.
